(19) United States
(12) Patent Application Publication
(10) Pub. No.: US 2008/0012937 A1
(43) Pub. Date: Jan. 17, 2008

(54) A/V display device capable of swapping digital/Analog A/V output modules

(76) Inventors: Mark Lee, Taipei (TW); Jung-Chang Wu, Taipei (TW); Wei-Yu Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/485,998

(22) Filed: Jul. 14, 2006

(51) Int. Cl. H04N 7/18

(52) U.S. Cl. 348/61

(57) ABSTRACT

An audio/video (A/V) display device capable of swapping digital/Analog A/V output modules mainly comprises a socket set up for inserting a digital/Analog A/V output module. By swapping different digital/Analog A/V output modules, said A/V display device can let users watch digital TV and DVD discs, browse photos stored in a memory card, organize data in said memory card, or play video games, etc.

### BACKGROUND OF THE INVENTION

1. Field of the invention

The present invention is related to an A/V (audio/video) display device capable of swapping digital/Analog A/V output modules, and more particularly, to an A/V display device which can provide different services by swapping different A/V output modules.

2. Description of the Prior Art

People like to pursuit all kinds of visual/hearing pleasure and entertainment. Before television was invented, radio is the main source for people to get information and entertainment. But as television (TV) becoming popular, there hasn't been much improvement on the radio all through the years, meanwhile, LCD TV, even PDP TV, is gradually taking the place of cathode ray tube (CRT) TV. Therefore, it is safe to say that people like to have all kinds of visual/hearing pleasure and entertainment.

However, while people enjoy the entertainment brought by TVs, they also find out that TV is not portable, i.e. people can't bring TVs with them to watch TV programs everywhere. Therefore, various kind of portable TV sets were invented, even many derivatives such as: portable DVD player, iPod, portable digital TV receiver, pocket-size game console were invented for people to receive information visually to be entertained and to bring such devices along with them.

Although many portable devices were introduced to fulfill people's needs, these devices still have some shortcomings after used for some times. For example, people who want to buy or use portable DVD players will find that portable DVD players are limited by the availability of new DVD titles and the high tag price of new portable DVD players, therefore, people often have to replay old films over and over again until they get tired of them, or to wait for new titles so they would use their portable DVD players. Besides, digital TV broadcasting is limited by its availability only to some areas, insufficient programs compared to traditional terrestrial TV broadcasting, during working hours, most programs on digital TV are replayed dramas or news programs, while on holiday or non-working hours, people tend to choose cable or satellite TV over digital TV, or go out for fin, hence, most people seldom use portable digital TV receivers unless for specific occasions such as camping or barbeque.

Furthermore, the above mentioned devices can only execute one single function, that is, if a user wants to watch TV and DVD discs when he is going out, he/she has to carry both portable digital TV receiver and portable DVD player along with him/her, making it inconvenient for outdoor use.

In view of the above-described deficiencies of traditional portable display devices, after years of constant effort in research, the inventor of this invention has consequently developed and proposed an A/V display device capable of swapping digital/Analog A/V output modules in the present invention.

### SUMMARY OF THE INVENTION

It is an object of the present invention to provide an audio/video (A/V) display device capable of swapping digital/Analog A/V output modules which can provide different services by swapping different A/V output modules based on user's requirement.

It is another object of the present invention to provide an A/V display device capable of swapping digital/Analog A/V output modules in one single device to provide different services by swapping different A/V output modules based on user's requirement.

In order to achieve the above mentioned objectives, the present invention discloses an A/V display device capable of swapping digital/Analog A/V output modules, mainly comprises:

an A/V display device having a socket set up thereon; and

a digital/Analog A/V output module for inserting in the socket.

### BRIEF DESCRIPTION OF THE DRAWINGS

The drawings disclose an illustrative embodiment of the present invention which serves to exemplify the various advantages and objects hereof, and are as follows:

FIG. 1 illustrates a 3D perspective view of an A/V display device capable of swapping digital/Analog A/V output modules in the present invention;

FIG. 2 illustrates a 3D perspective view of a first embodiment of an A/V display device capable of swapping digital/Analog A/V output modules in the present invention;

FIG. 3 illustrates a 3D perspective view of a second embodiment of an A/V display device capable of swapping digital/Analog A/V output modules in the present invention;

FIG. 4 illustrates a 3D perspective view of a third embodiment of an A/V display device capable of swapping digital/Analog A/V output modules in the present invention;

FIG. 5 illustrates a 3D view of a fourth embodiment of an A/V display device capable of swapping digital/Analog A/V output modules in the present invention; and

FIG. 6 illustrates a 3D perspective view of a fifth embodiment of an A/V display device capable of swapping digital/Analog A/V output modules in the present invention.

### REFERENCE NUMERALS

| | |
|---|---|
| 1 | A/V display device |
| 11 | socket |
| 12 | key |
| 13 | display |
| 2 | digital/Analog A/V output module |
| 21 | DVD player |
| 211 | DVD disc |
| 22 | digital TV receiver (or DVD-T) |
| 23 | digital card reader |
| 231 | memory card |
| 24 | Hard Disk |
| 25 | game console |
| 26 | Bluetooth transmitting module |
| 3 | port |

### DETAILED DESCRIPTION OF THE PREFERRED EMBODIMENT

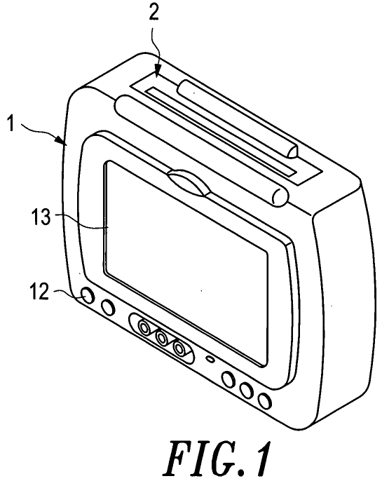

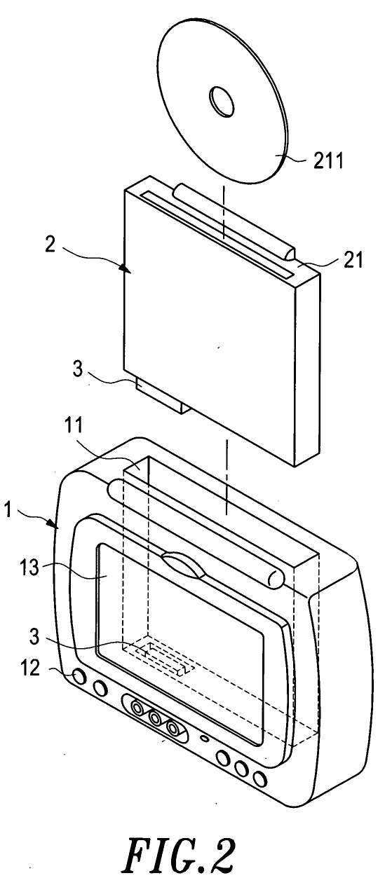

Please refer to FIG. 1 and FIG. 2. The present invention discloses an audio/video (A/V) display device capable of swapping digital/Analog A/V output modules mainly comprising a socket 11 set up on a A/V display device 1, socket 11 having a port 3 for connecting to port 3 of a digital/Analog A/V output module 2 to show digital/Analog A/V content converted by digital A/V output module 2 on A/V display device 1.

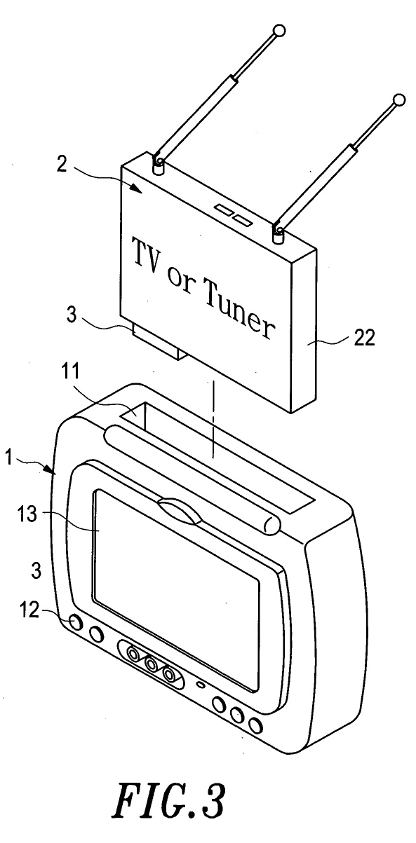

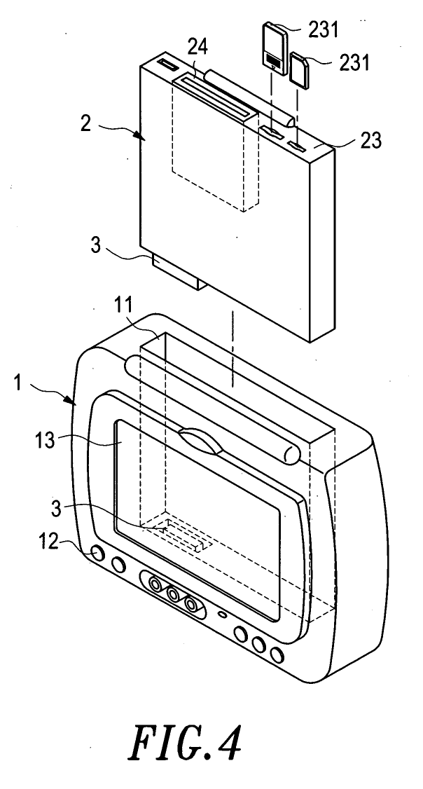

Please refer to FIG. 2, FIG. 3 and FIG. 4. The A/V display device capable of swapping digital/Analog A/V output modules can swap digital/Analog A/V output modules 2 based on user's requirement. For example, when a user finds out that there are no desired programs to watch on digital TV or the reception is poor, he/she can take out a digital TV receiver (or DVD-T) 22 from socket 11 of A/V display device 1, and then inserts DVD player 21 to watch a DVD disc 211 Besides, he/she can also insert digital card reader 23 into socket 11 of A/V display device 1, and then presses the keys 12 on A/V display device 1 to browse photos stored in a memory card 231 of digital still camera on a display 13 of A/V display device 1 or to organize the data stored in memory card 231.

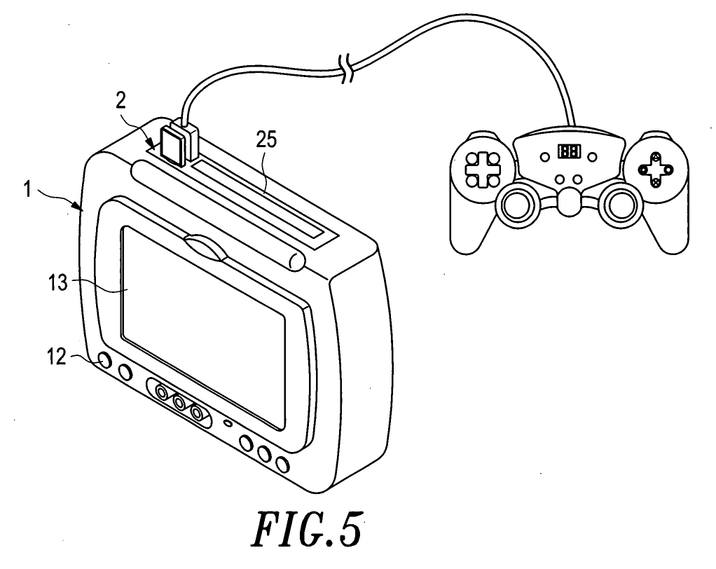

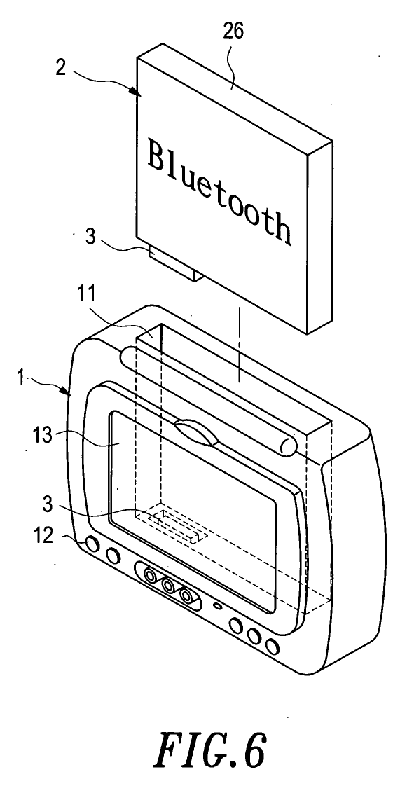

Furthermore, in the audio/video (A/V) display device capable of swapping digital A/V output modules disclosed in the present invention, digital A/V output module 2 can be a hard disk 24 (as shown in FIG. 4) or an i-POD adapter, a game console 25 (as shown in FIG. 5), a Bluetooth transmitting module 26 which can receive a Bluetooth signal (as shown in FIG. 6), or any kind of digital data converters and digital A/V data converting devices to provide users with versatile choices without limiting to one single function/device.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An audio/video (A/V) display device capable of swapping digital/Analog A/V output modules, characterized in that said A/V display device comprises a socket set up for inserting a digital/Analog A/V output module, said A/V display device can provide different services by swapping different digital A/V output modules having different functions.

2. The audio/video (A/V) display device capable of swapping digital/Analog A/V output modules as recited in claim 1, wherein said digital/Analog A/V output module is a DVD player.

3. The audio/video (A/V) display device capable of swapping digital A/V output modules as recited in claim 1, wherein said digital/Analog A/V output module is a digital card reader.

4. The audio/video (A/V) display device capable of swapping digital A/V output modules as recited in claim 1, wherein said digital/Analog A/V output module is a digital TV receiver.

5. The audio/video (A/V) display device capable of swapping digital A/V output modules as recited in claim 1, wherein said digital/Analog A/V output module is a hard disk.

6. The audio/video (A/V) display device capable of swapping digital A/V output modules as recited in claim 1, wherein said digital/Analog A/V output module is an i-POD adapter.

7. The audio/video (A/V) display device capable of swapping digital A/V output modules as recited in claim 1, wherein said digital/Analog A/V output module is a Bluetooth transmitting module which can receive a Bluetooth signal.

8. The audio/video (A/V) display device capable of swapping digital A/V output modules as recited in claim 1, wherein said digital/Analog A/V output module is a game console.

9. The audio/video (A/V) display device capable of swapping digital/Analog A/V output modules as recited in claim 1, wherein said digital/Analog A/V output module can be any kind of digital data converters.

10. The audio/video (A/V) display device capable of swapping digital A/V output modules as recited in claim 1, wherein said digital/Analog A/V output module can be any kind of digital A/V data converting devices.
